(19) United States
(12) Patent Application Publication
(10) Pub. No.: US 2007/0112571 A1
(43) Pub. Date: May 17, 2007

(54) Speech recognition at a mobile terminal

(76) Inventor: Murugappan Thirugnana, Irving, TX (US)

Correspondence Address: Hollingsworth & Funk, LLC, Suite 125, 8009 34th Avenue South, Minneapolis, MN, 55425, US

(21) Appl. No.: 11/270,967

(22) Filed: Nov. 11, 2005

(51) Int. Cl. G10L 19/00

(52) U.S. Cl. 704/270; 704/201

(57) ABSTRACT

Informational text is provided to a mobile terminal capable of being coupled to a mobile communications network. Digitally-encoded voice data is received at the mobile terminal via the network. The digitally-encoded voice data is converted to text via a speech recognition module of the mobile terminal. Informational portions of the text are identified and made available to an application of the mobile terminal. In one configuration, speech recognition quality can be improved by extracting the informational text from the near-end speech, and comparing to the text obtained from the received voice data. In another configuration, an analog signal that originates from a public switched telephone network is received at an element of a mobile network. Speech recognition is performed on the analog signal to obtain text that represents conversations contained in the analog signal. The analog signal is encoded to form digitally-encoded voice data suitable for transmission to the mobile terminal. The voice data and the text are then transmitted to the mobile terminal.

### FIELD OF THE INVENTION

This invention relates in general to data communications networks, and more particularly to speech recognition in mobile communications.

### BACKGROUND OF THE INVENTION

Mobile communications devices such as cell phones are becoming nearly ubiquitous. The popularity of these devices is due to their portability as well as the advanced features being added to such devices. Modern cell phones and related devices offer an ever-growing list of digital capabilities. The portability of these devices makes them ideal for all manner of personal and professional communications.

Even with all of the digital features being added to cellular phones, these devices are still primarily used for voice communications. These voice communications may take place over any combination of cellular provider networks, public-switched telephone networks, and other data transmission means, such as Push-To-Talk (PTT) or Voice-Over Internet Protocol (VoIP).

One problem in receiving information over a voice connection is that it is difficult to capture certain types of data that is communicated via voice. An example of this textual data such as phone numbers and addresses. This data is commonly communicated by voice, but can be difficult to remember. Typically, the recipient must fix the data using pen and paper or enter it into an electronic data storage device so that the data is not forgotten.

Jotting down information during a phone call may be easily done sitting at a desk. However recording such data is difficult in situations that are often encountered by mobile device users. For example, it may be possible to drive while talking on cell phone, but it would be very difficult (as well as dangerous) to try and write down an address while simultaneously talking on a cell phone and driving. Cell phone users may also find themselves in situations where they do not have ready access to a pen and paper or any other way to record data. The data may be entered manually into the phone, but this could be distracting, as it may require that the user to break off the conversation in order to enter data into a keypad of the device.

One solution may be to include a voice recorder in the telephone. However, this feature may not be supported in many phones. In addition, storing digitized voice data requires a large amount of memory, especially if the call is long in duration. Memory may be at a premium in mobile devices. Finally, the data contained in a voice recording is not easily accessible. The recipient must retrieve the stored conversation, listen for the desired data, and then write down the data or otherwise manually record it. Therefore, an improved way to capture textual data from a voice conversation is desirable.

### SUMMARY OF THE INVENTION

The present disclosure relates to speech recognition in mobile communications networks. In accordance with one embodiment of the invention, a processor-implemented method of providing informational text to a mobile terminal involves receiving digitally-encoded voice data at the mobile terminal via the network. The digitally-encoded voice data is converted to text via a speech recognition module of the mobile terminal. Informational portions of the text are identified and the informational portions are made available to an application of the mobile terminal.

In more particular embodiments, the method involves identifying contact information in the text, and may involve adding the contact information of the text to a contacts database of the mobile terminal. Identifying the informational portions of the text may involve identifying at least one of a telephone number and an address in the text.

In another, more particular embodiment, converting the digitally-encoded voice data to text via the speech recognition module of the mobile terminal involves extracting speech recognition features from the digitally-encoded voice data. The speech recognition features are sent to a server of a mobile communications network. The features are converted to the text at the server, and the text is sent from the server to the mobile terminal.

In another, more particular embodiment, the method involves performing speech recognition on a portion of speech recited by a user of the mobile terminal to obtain verification text. The portion of speech is the result of the user repeating an original portion of speech received via the network. The accuracy of the informational portions of the text is verified based on the verification text.

In other arrangements, the method may involve receiving analog voice at the mobile terminal via the network, and converting the analog voice to text via the speech recognition module of the mobile terminal. In another configuration, converting the digitally-encoded voice data to text via the speech recognition module of the mobile terminal may involve performing at least a portion of the conversion the digitally-encoded voice data to text via a server of a mobile communications network and sending the text from the server to the mobile terminal using a mobile messaging infrastructure. The mobile messaging infrastructure may include at least one of Short Message Service and Multimedia Message Service.

In another, more particular embodiment, the method involves converting the digitally-encoded voice data to text in response to detecting a triggering event. The triggering event may be detected from the digitally-encoded voice data, and may include a voice intonation and/or a word pattern derived from the digitally-encoded voice data.

In another embodiment of the invention, a processor-implemented method of providing informational text to a mobile terminal, includes receiving an analog signal at an element of a mobile network. The analog signal originates from a public switched telephone network. Speech recognition is performed on the analog signal to obtain text that represents conversations contained in the analog signal. The analog signal is encoded to form digitally-encoded voice data suitable for transmission to the mobile terminal. The digitally-encoded voice data and the text are transmitted to the mobile terminal.

In more particular embodiments, the method involves identifying informational portions of the text and making the informational portions available to an application of the mobile terminal. In one arrangement, the method may involve identifying contact information in the text and adding contact information of the text to a contacts database of the mobile terminal.

In another more particular embodiment, the method involves performing speech recognition on a portion of speech recited by a user of the mobile terminal to obtain verification text. The portion of speech is formed by the user repeating an original portion of speech received at the mobile terminal via the network. The accuracy of the informational portions of the text is verified based on the verification text.

In another embodiment of the invention, a mobile terminal includes a network interface capable of communicating via a mobile communications network. A processor is coupled to the network interface and memory is coupled to the processor. The memory has at least one user application and a speech recognition module that causes the processor to receive digitally-encoded voice data via the network interface. The processor performs speech recognition on the digitally-encoded voice data to obtain text that represents speech contained in the encoded voice data. Informational portions of the text are identified by the processor, and the informational portions of the text are made available to the user application.

In more particular embodiments, the informational portions of the text includes at least one of contact information, a telephone number, and an address. The user application may include a contacts database, and the speech recognition module may cause the processor to make the contact information available to the contacts database.

In another, more particular embodiment, the speech recognition module may be further configured to cause the processor to extract speech recognition features from the digitally-encoded voice data received at the mobile terminal, send the speech recognition features to a server of the mobile communications network to convert the features to the text at the server, and receive the text from the server. In another arrangement, the speech recognition module causes the processor to perform at least a portion of the conversion of the digitally-encoded voice data received at the mobile terminal to text via a server of the mobile communications network. At least a portion of the text is received from the server. The terminal may include a mobile messaging module having instructions that cause the processor to receive at least the portion of the text from the service using a mobile messaging infrastructure. The mobile messaging module may use at least one of Short Message Service and Multimedia Message Service.

In another, more particular embodiment, the mobile terminal includes a microphone, and the speech recognition module is further configured to cause the processor to perform speech recognition on a portion of speech recited by a user of the mobile terminal into the microphone to obtain verification text. The portion of speech is formed by the user repeating an original portion of speech received at the mobile terminal via the network interface. The accuracy of the informational portions of the text is then verified based on the verification text.

In another embodiment of the present invention, a processor-readable medium has instructions which are executable by a data processing arrangement capable of being coupled to a network to perform steps that include receiving encoded voice data at the mobile terminal via the network. The encoded voice data is converted to text via an advanced speech recognition module of the mobile terminal. Informational portions of the text are identified and made available to an application of the mobile terminal.

In another embodiment of the present invention, a system includes means for receiving analog voice data originating from a public switched telephone network; means for performing speech recognition on the analog voice data to obtain text that represents conversations contained in the analog voice data; means for encoding the analog voice data to form encoded voice data suitable for transmission to the mobile terminal; and means for transmitting the encoded voice data and the text to the mobile terminal.

In another embodiment of the present invention, a data-processing arrangement includes a network interface capable of communicating with a mobile terminal via a mobile network and a public switched telephone network (PSTN) interface capable of communicating via a PSTN. A processor is coupled to the network interface and the PSTN interface. Memory is coupled to the processor. The memory has instructions that cause the processor to receive analog voice data originating from the PSTN and targeted for the mobile terminal; perform speech recognition on the analog voice data to obtain text that represents conversations contained in the analog voice data; encode the analog voice data to form encoded voice data suitable for transmission to the mobile terminal; and transmit the encoded voice data and the text to the mobile terminal.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 is a block diagram illustrating a wireless automatic speech recognition system according to embodiments of the present invention;

FIG. 2 is a block diagram illustrating an example use of a telecommunications automatic speech recognition data capture service according to an embodiment of the present invention;

FIG. 3 is a block diagram illustrating another example use of a telecommunications automatic speech recognition data capture service according to an embodiment of the present invention;

FIG. 4 is a block diagram illustrating speech recognition occurring on a mobile terminal according to embodiments of the invention;

FIG. 5 is a block diagram illustrating a dual-mode capable mobile device according to embodiments of the present invention;

FIG. 6 is a block diagram illustrating an example mobile services infrastructure incorporating automatic speech recognition according to embodiments of the present invention;

FIG. 7 is a block diagram illustrating a mobile computing arrangement capable of automatic speech recognition functions according to embodiments of the present invention;

FIG. 8 is a block diagram illustrating a computing arrangement 800 capable of carrying out automatic speech recognition and/or distributed speech recognition infrastructure operations according to embodiments of the present invention;

FIG. 9 is a flowchart illustrating a procedure for providing informational text to a mobile terminal capable of being coupled to a mobile communications network according to embodiments of the present invention;

FIG. 10 is a flowchart illustrating procedure for providing informational text to a mobile terminal that is communicating via the PSTN according to embodiments of the present invention; and

FIG. 11 is a flowchart illustrating procedure for triggering voice recognition and text capture according to an embodiment of the invention.

### DETAILED DESCRIPTION OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present disclosure is directed to the use of automatic speech recognition (ASR) for capturing textual data for use on a mobile device. The present invention allows information such as telephone numbers and addresses to be recognized and captured in text form while on a call. Although the invention is applicable in any telephony application, it is particularly useful for mobile device users. The invention enables mobile device users to automatically capture text data contained in conversations and add that data to a repository on the device, such as an address book. The data can be readily accessed and used without the end user having to manually enter data or otherwise manipulate a manual user interface of the device.

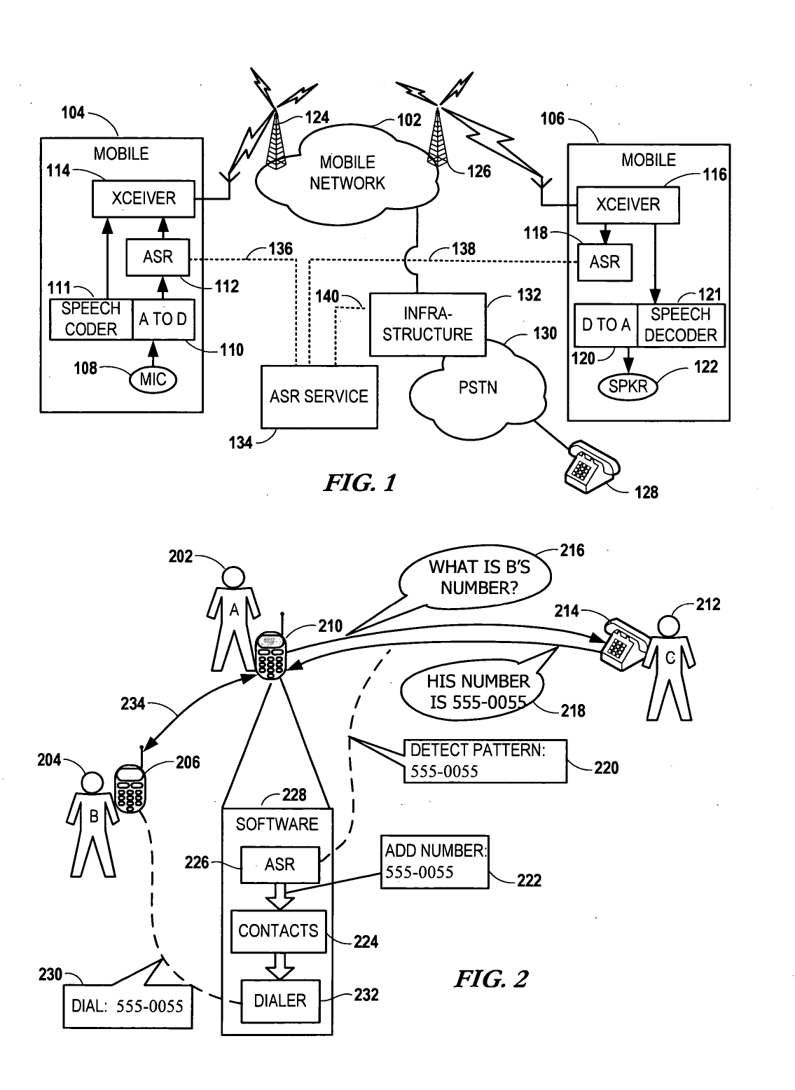

Technologies such as ASR have proven to be valuable in directory assistance, automatic calling and other voice telephony applications over wired circuits. It will be appreciated that improvements in wired speech recognition can also be applied to wireless systems as wireless systems continue to proliferate. In reference now to FIG. 1, a diagram of a wireless ASR system according to embodiments of the present invention is illustrated. Generally, a mobile network 102 provides wireless voice and data services for mobile terminals 104, 106, as known in the art.

In the arrangement of FIG. 1, the first mobile terminal 102 includes voice and data transmission components that include a microphone 108, analog-to-digital (A-D) converter 110, speech coder 111, ASR module 112, and transceiver 114. The second mobile terminal 104 include voice and data receiving equipment that includes a transceiver 116, an ASR module 118, a digital-to-analog (D-A) converter 120, and a speaker 122. Those skilled in the art will appreciate that the illustrated arrangement is simplified; terminals 104 and 106 will usually include both transmission and receiving components.

In traditional wireless communications system, speech at the mobile microphone 108 is digitized via the A-D converter 110 and encoded by the speech coder 111 defined for the system. The encoded speech parameters (also referred to herein as “coded speech’) are then transmitted by the mobile transceiver 114 to a base station 124 of the mobile network 102. If the destination for the voice traffic is another mobile device (e.g., terminal 106), the encoded voice data is received at the transceiver 116 via a second base station 126. The speech decoder 121 decodes the received voice data and sends the decoded voice data to the D-A converter 120. The resulting analog signal is sent to the speaker 122. If the destination for the voice traffic is a telephone 128 connected to the public switched telephone network (PSTN) 130, then the coded speech data is sent to an infrastructure element 132 that is coupled to both the mobile network 102 and the PST 130. The infrastructure element 132 decodes the received coded speech to produce sound suitable for communication over the PST 130. The ASR modules 112, 118 may optionally utilize some elements of the infrastructure 132 and/or ASR service 134, as indicated by logical links 136, 138, and 140. These logical links 136, 138, 140 may involve merely the sharing of underlying formats and protocols, or may involve some sort of distributed processing that occurs between the terminals 104, 106 and other infrastructure elements.

The mobile terminals 104, 106 may differ from existing mobile devices by the inclusion of the respective ASR modules 112, 118. These modules 112, 118 may be capable of performing on-the-fly voice recognition and conversion into text format, or may perform some or all such tasks in coordination with an external network element, such as the illustrated ASR service element 134. Besides enabling voice recognition, the ASR modules 112, 118 may also be capable of sending and receiving text data related to the voice traffic of an ongoing conversations. This text data may be sent directly between terminals 104, 106, or may involve an intermediary element such as the ASR service 112.

The sending and receiving of text data from the ASR modules 112, 118 may also involve signaling to initiate/synchronize events, communicate metadata, etc. This signaling may be local to the device, such as between ASR modules 112, 118 and respective user interfaces (not shown) of the terminals 104, 106 to start or stop recognition. Signaling may also involve coordinating tasks between network elements, such as communicating the existence, formats, and protocols used for exchanging voice recognition text between mobile terminals 104, 106 and/or the ASR service.

Generally, the ASR service 112 may be implemented as a communications server and provide numerous functions such as text extraction, text buffering, message conversion/routing, signaling, etc. The ASR service 112 may also be implemented on top of other network services and apparatus, such that a dedicated server is not required. For example, certain ASR functions (e.g., signaling) can be implemented using extensions to existing communications protocols as Session Initiation Protocol (SIP).

The arrangement of network elements in FIG. 1 is merely for purposes of illustration. Various alternate network arrangements may be used to provide the functionality as described herein. In reference now to FIG. 2, a block diagram illustrates an example use of a telecommunications ASR data capture service according to an embodiment of the present invention. In this example, person A 202 is driving and suddenly remembers that he has to call person B 204. Person A 202 doesn't know the number of person B's new phone 206. Instead, person A 202 uses his mobile phone 210 to calls person C 212 via a standard landline phone 214 and asks (216) for the phone number of person B 204. Person C 212 merely recites (218) the phone number, and the number is detected (220) and added (222) to a contact list 224 of person A's terminal 210. In the illustrated arrangement, the detection (220) is accomplished partly or entirely by an ASR module 226 that is part of software 228 running on the terminal 210.

After the terminal software 228 saves (222) the number in contact list 224, person A 202 can terminate the call with person C 212 and then dials (230) person B 204. This dialing (230) may be initiated through dialer module 232 that interfaces with the contacts list 224. The dialer 232 may initiate dialing (230) via a manual input (e.g., pressing a key) or by some other means, such as voice commands. After the call is initiated by the dialer 232, persons A and B 202, 204 can engage in a conversation (234).

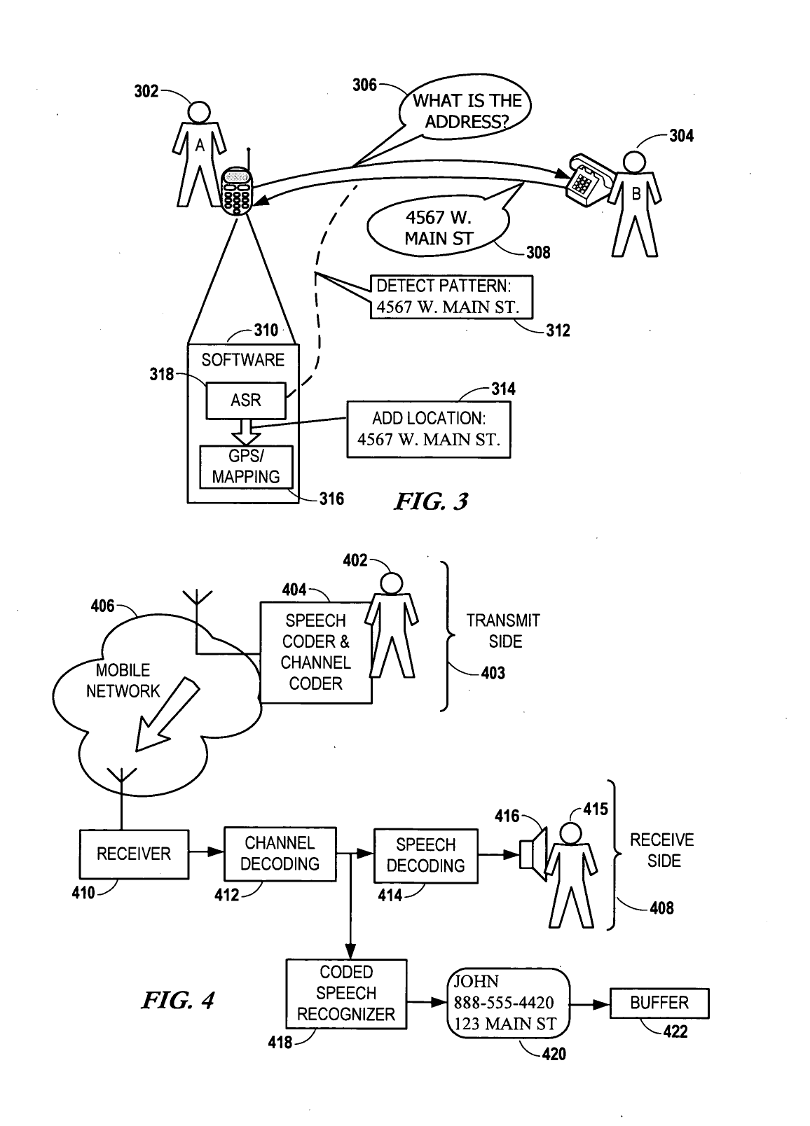

Another use case involving mobile terminal ASR according to an embodiment of the present invention is shown in the block diagram of FIG. 3. In this example, person A 302 is downtown and calls (306) person B 304 on order to find an address that person A 302 wants to visit. Person B 304 dictates (308) the address, the phone software 310 detects (312) the information and saves it (314). The phone software 310 may simply store the address in memory, or provide the location to another application, such as the illustrated Global Positioning Satellite (GPS) and mapping application 316. The GPS/mapping application 316 can detect person A's current geolocation and provide maps and directions in order to guide person A 302 to the requested address.

In the example shown in FIG. 3, the phone may perform the speech recognition and text conversion internally via an ASR module 318. Alternatively, the recognition and conversion may occur somewhere else on the mobile network. In this latter arrangement, the mobile service provider may deliver the conversation text to the user 302 using an existing communication means, such as Short Messaging Service (SMS) or email. The delivery of the text to the user 302 may be automatic, or may be in response to a user-initiated triggering event. For example, the user 302 may simply press a control item labeled “Get Transcript From Last Call,” and the text will be received (314) by the mechanism defined in the user's preferences.

FIG. 4 illustrates a case where speech recognition according to embodiments of the invention occurs on the receiver's mobile terminal. In this example, a user 402 on the transmit side 403 has voice signals encoded by a speech and channel encoder 404. The encoder 404 transforms audio signals into digital parameters that are suitable for transmission over data networks. The encoder 404 further processes these parameters by applying channel encoding. Channel encoding protects against channel impairments during transmission. The processing at the encoder 404 is usually done on a frame basis (typically using a frame length of 20 milliseconds).

After processing by the encoder 404, the encoded data is transmitted via a wireless channel of a mobile network 406. Note that the transmitting user 402 may be talking either from a mobile phone or using a landline phone. In the latter case, the encoder 404 may reside on the mobile network 406 instead of the user's telephone. In other network architectures, the multiple encoders may be used. For example, a call placed via VoIP may have speech coding applied at the originating device, and different speech coding (e.g., transcoding) and/or channel coding applied at the mobile network encoder 404.

At the receiving side 408 of the voice transmission, the demodulated signal is detected at a receiver 410 and passed through a channel decoder 412 to get the original transmitted parameters back. These channel decoded speech parameters are then given to a speech decoder 414. The speech decoder 414 transforms the parameters back into analog signals for playback to the listener 415 via a speaker 416. The speech parameters obtained by the channel decoder 412 may also be passed to a coded speech recognizer 418. The coded speech recognizer 418 performs the speech recognition, which includes transforming speech into text 420. The coded speech parameters are collected at the recognizer 418 from frames leaving the channel decoder 412. The recognizer 418 may first extract certain recognition features from the received coded speech and then do recognition. The extracted features may include cepstral coefficients, voiced/unvoiced information, etc. The feature extraction of the coded speech recognizer may be adapted for use with any speech coding scheme used in the system, including, various GSM AMR modes, EFR, FR, CDMA speech codecs, etc.

It should be noted that the illustrated embodiments are independent of the actual implementation of speech recognition used by the recognizer 418. In the illustrated example, the speech recognizer 418 is able to work with the coded speech parameters received from the channel decoder 412. However, the recognizer 418 may be capable of performing additional encoding/decoding/transcoding on the voice data, depending on the end-use environment.

The coded speech recognizer 418 converts the received speech into text 420, which may contain a collection of letters and numbers. This text 420 may be used in its raw format, or may be subject to further processing. For example, the text may be subject to a contextual grammar analysis to determine whether the chosen translations make sense according to the language rules. The text 420 may also be parsed in order to extract information text. Generally, informational text is any text that the user will want to store for later use. Informational text may include, but is not limited to names, addresses, phone numbers, passwords, identifying numbers, etc. The entire text 420 may be saved in a general-purpose buffer 422. The buffer 422 may be persistent or non persistent. If an informational subset (e.g., name, address and phone number) of the text 420 is extracted, the subset of data be directed to a specialized application (e.g., a contacts manager).

As described in the example of FIG. 4, the speech decoding can be independent of the type of telephony equipment used on the transmitting side 403. This is because the mobile network 406 will generally convert voice data to a common digital format. However, some locations still rely on analog voice communications as a fall back mode when there is no digital coverage available. For example in North America (e.g., IS 136 systems) when digital coverage in an area is not available, the mobile may fall back to analog mode (e.g., AMPS). A similar arrangement is utilized in CDMA IS 2000 systems.

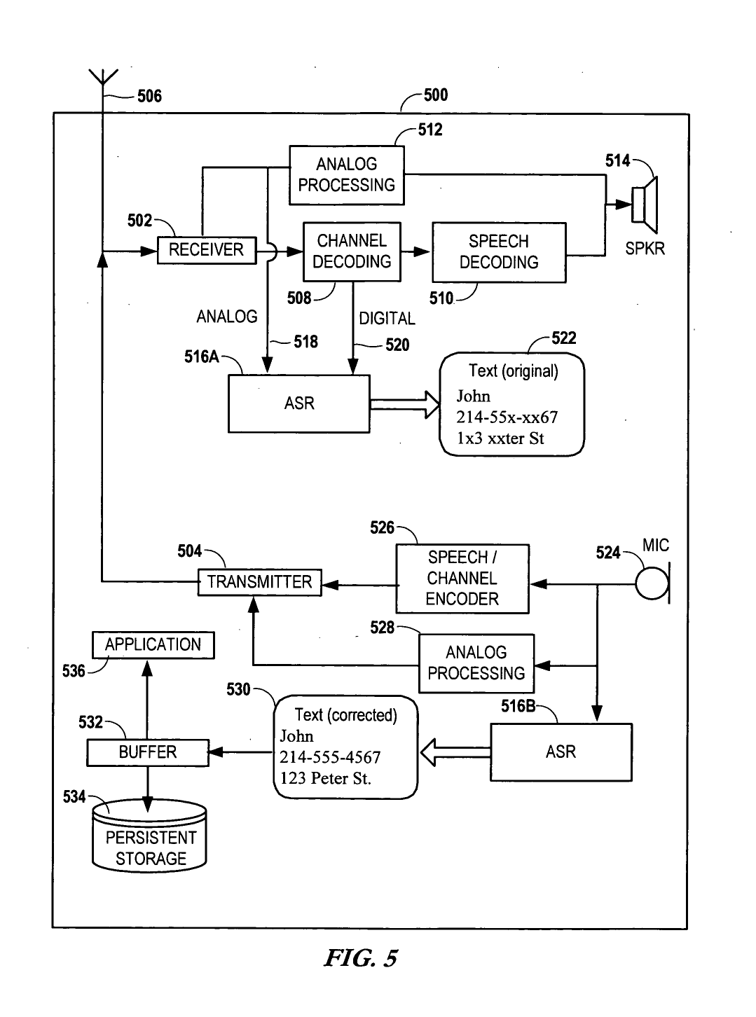

Many phones may have a dual-mode capability, such that they can communicate on both analog and digital networks. However, the ASR modules can be adapted to deal with a dual mode setup. An arrangement of a dual-mode capable mobile device 500 according to embodiments of the present invention is shown in FIG. 5. Generally, the mobile terminal 500 includes a receiver 502 and transmitter 504 coupled to an antenna 506.

In order to process digital data transmissions, a channel decoder 508 and voice decoder 510 perform data conversions as described above in relation to FIG. 4. In addition, an analog processing module 512 can be used to handle voice traffic when the terminal 500 is operating in analog mode (e.g., using an AVCH channel). Outputs from either the analog module 512 or the speech decoder 510 are sent to a speaker 514. In addition, an ASR module 516A is adapted to perform text conversion on speech in either analog or digital formats, as illustrated by respective paths 518 and 520. The ASR module 516A may have separate sub-modules for processing speech received from each path 518, 520. Alternatively, the ASR may have an A-D converter used to pre-process the analog path 518.

One disadvantage in using speech received via mobile links is that the sound quality is often inferior to that of landline telephony systems. Therefore, the ASR module 516A may have difficulty in properly recognizing text received on the mobile terminal 500, resulting in conversion errors. These errors are represented in the text excerpt 522, which has “x's” representing areas of unrecognizable speech. Conversion errors can additionally be exacerbated by factors besides the sound quality of the data link. For example, the sender's speech characteristics (e.g., accents) and ambient noise may contribute to conversion errors. Therefore, the terminal 500 may include an extension 516B to the ASR module 516A that allows the user of the mobile terminal 500 to improve the accuracy of captured informational text.

Generally, the ASR module 516B works on the transmission side of the mobile terminal 500. The transmission portion includes a microphone 524, speech/channel encoder(s) 526, and optionally an analog processor 528 if the terminal 500 is dual-mode-capable. The voice signals from the microphone 524 are processed by the encoder 526 and/or analog processor 528 and sent out via the transmitter 504. It will be appreciated that the quality of the voice signal that is output from the microphone 524 will generally be of superior quality that that received at via analog and digital paths 518, 520 on the receive side. Therefore, the ASR module 516B can use voice signals from the microphone 524 to perform verification on the captured text 522.

The ASR module 516B operates when the user of the terminal 500 repeats portions of speech that is used to form the desired informational text 522. Thus the ASR can capture text converted via the microphone 524 and compare it to the captured text 522 from the receive side. This comparison can be used to interpolate missing information and form a verified version 530 of the converted text. This verification of the ASR conversion can mitigate effects of poor sound quality of received voice, as well as mitigating other effects such as speech characteristics of the either speaker.

Depending on user settings and the implementation, the received text 522, 530 may be kept in a buffer 532. The buffer 532 may be implemented in volatile or non-volatile memory, and may use any number of buffering schemes (e.g., first-in-first-out, circular buffer, etc.). Data contained in the buffer 532 may be manually or automatically placed in a persistent storage 534 for access by the user (e.g., as a file). The data from the buffer 532 may be used as input to an application program 536. For example, data may be automatically saved in the user's contact list or the user's notes. Alternately, one of the applications 536 may prompt the user once the call ends. The user can then direct the application 536 to save the buffered data in a chosen location and format.

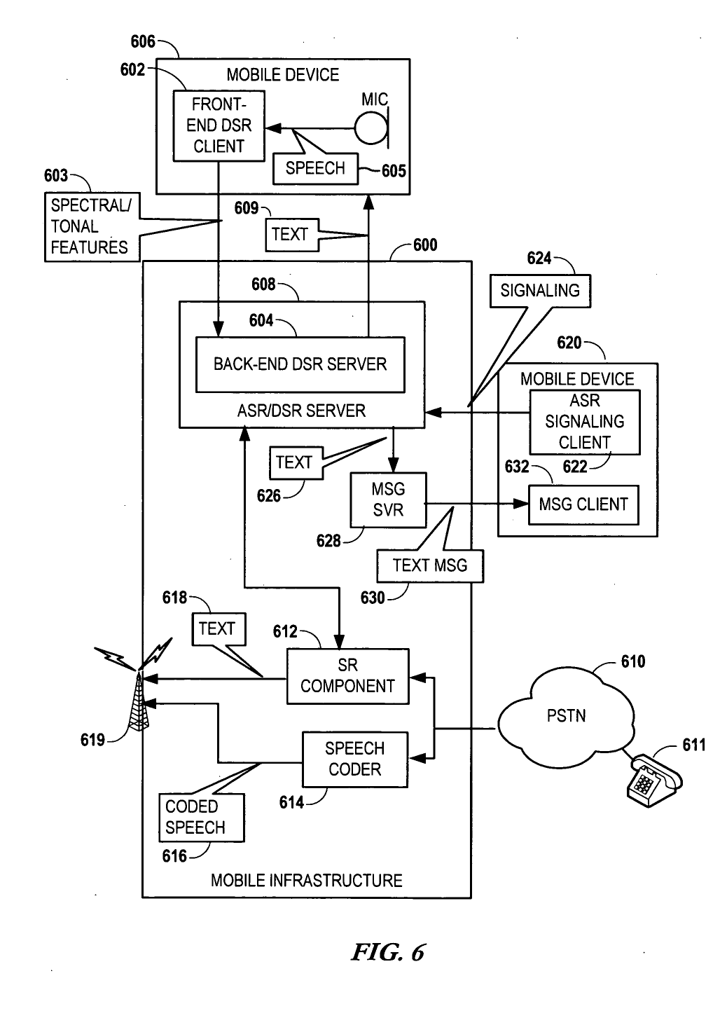

In the illustrated example of FIG. 5, all of the speech recognition activities occur on the mobile terminal 500. However, it is also possible to move some or all of the recognition processing to the mobile service infrastructure. An example of a mobile services infrastructure 600 incorporating ASR according to embodiments of the present invention is shown in FIG. 6.

Generally, the infrastructure 600 utilizes server based speech recognition as part of the underlying technology. The speech recognition may be implemented in a client-server or distributed fashion. For example, the European Telecommunications Standards Institute (ETSI) is standardizing one such system called Aurora. Aurora is a distributed speech recognition (DSR) system. FIG. 6 illustrates a possible implementation using a DSR approach.

In a DSR implementation, voice recognition is divided into at least two components, a front-end client 602 and back-end server 604. At the front end 602, spectral and tonal features 603 are extracted from speech 605. These features 603 are compressed and sent to back-end server 604 located in the mobile infra-structure 600. The features can be sent to the back-end 604 over a data channel and/or a voice channel, depending on the implementation.

In the illustrated DSR arrangement, the mobile devices (e.g., device 606) include only the front-end client 602. The back end 604 is implemented in one or more server components 608 of the infrastructure 600. The back-end server 604 is where the actual recognition is performed, e.g., where the features 603 detected at the front-end 602 are converted to text 609. The server can return the resulting text 609 to the mobile device 606 either via messages, a data channel, and/or data embedded in a voice channel, depending on the implementation.

FIG. 6 illustrates additional features that may be provided in the mobile network ASR infrastructure 600. In particular, the infrastructure 600 is adapted to deliver ASR-derived text to mobile devices 606 for calls placed via the PSTN 610. For example, where the person talking is using a standard telephone 611, a speech recognition (SR) component 612 of the infrastructure 600 can do the speech recognition either before, after, or parallel with speech encoding that is applied at a legacy speech encoder 614. The SR component 612 can provide full speech-to-text conversion, or may include a DSR client (e.g., client 602) that extracts features from the speech and passes the features to a back-end server 604 for text recognition. Both coded speech 616 and text 618 can be passed to mobile receivers via a wireless infrastructure base station 619.

Although in some implementations, mobile devices may have entirely self-contained ASR, at least some ASR services may be desirable in the infrastructure 600 in order to perform recognition tasks before speech is coded. In addition, if ASR is included in the infrastructure, mobile devices that do not have built-in ASR capability can still utilize ASR services. For example, mobile device 620 may include an ASR signaling client 622 that is limited to signaling ASR events to network entities of the infrastructure 600. In the illustrated example, the ASR client 622 sends a signal 624 to ASR/DSR server 608 that instructs the ASR/DSR server 608 to begin speech recognition on an input and/or output voice channel used by the mobile device 620. In response, the ASR/DSR server 608 captures data from the voice channel and converts it to text 626.

The text 626 captured by the ASR/DSR server 608 may be buffered internally until ready for sending to the mobile device 620. The text 626 may also be sent to another network element, such as a message server 628, for further processing. When the signaling client 622 indicates that voice recognition should halt, the messaging server 628 can format the message (if needed) and send a text message 630 to the mobile device 620. The mobile device 620 includes a messaging client 632 that is capable of receiving and further processing the text message 630.

The message server 628 and message client 632 may use a format and protocol specially adapted for speech recognition. Alternatively, the message server 628 and message client 632 can use an existing text message framework, such as short message service (SMS) and multimedia messaging service (MMS). In this way, existing mobile devices 620 can utilize speech recognition by only adding the signaling client 622.

The infrastructure may also be adaptable to utilize ASR capable terminals as part of the infrastructure 600. For example, if a mobile device such as device 606 is already performing some or all ASR processing on one end of a phone conversation, the ASR signaling can make the text available to both parties via existing or specialized messaging frameworks. Therefore, if the user of mobile device 620 wants speech recognition processing of a conversation with mobile device 606, then the infrastructure can take advantage of the ASR processing occurring on device 606, even if the user of device 606 is not interested in the text of this particular conversation.

One advantage to having at least part of the ASR functionality existing in the infrastructure 600 is that voice servers can be upgraded and new voice recognition servers can be added with minimal impact to mobile device users. Also note that the delivery of text (e.g., via messaging components 628, 632 or directly as shown for text 609) can occur during the call (e.g., using an available data channel, thus making it a “rich” call) and/or after the call is over (e.g., post-conversation message delivery), depending on available channels, user preferences, phone capabilities, etc.

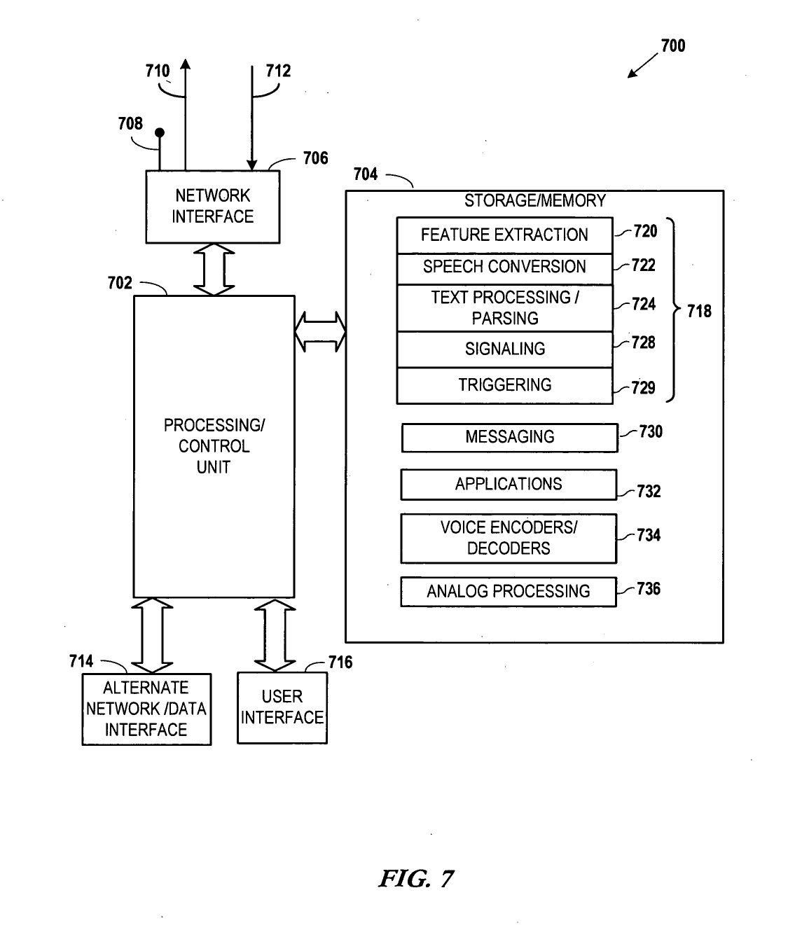

The communication devices that are able to take advantage of ASR features may include any communication apparatus known in the art, including mobile phones, digital landline phones (e.g., SIP phones), computers, etc. In particular, ASR features may be particularly useful in mobile devices. In FIG. 7, a mobile computing arrangement 700 is illustrated that is capable of ASR functions according to embodiments of the present invention. Those skilled in the art will appreciate that the exemplary mobile computing arrangement 700 is merely representative of general functions that may be associated with such mobile devices, and also that landline computing systems similarly include computing circuitry to perform such operations.

The illustrated mobile computing arrangement 700 may be suitable for processing data connections via one or more network data paths. The mobile computing arrangement 700 includes a processing/control unit 702, such as a microprocessor, reduced instruction set computer (RISC), or other central processing module. The processing unit 702 need not be a single device, and may include one or more processors. For example, the processing unit may include a master processor and associated slave processors coupled to communicate with the master processor.

The processing unit 702 controls the basic functions of the arrangement 700. Those functions associated may be included as instructions stored in a program storage/memory 704. In one embodiment of the invention, the program modules associated with the storage/memory 704 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 700 via data signals, such as being downloaded electronically via one or more networks, such as the Internet and an intermediate wireless network(s).

The program storage/memory 704 may also include operating systems for carrying out functions and applications associated with functions on the mobile computing arrangement 700. The program storage 704 may include one or more of read-only memory (ROM), flash ROM, programmable and/or erasable ROM, random access memory (RAM), subscriber interface module (SIM), wireless interface module (WIM), smart card, hard drive, or other removable memory device.

The mobile computing arrangement 700 includes hardware and software components coupled to the processing/control unit 702 for externally exchanging voice and data with other computing entities. In particular, the illustrated mobile computing arrangement 700 includes a network interface 706 suitable for performing wireless data exchanges. The network interface 706 may include a digital signal processor (DSP) employed to perform a variety of functions, including analog-to-digital (A/D) conversion, digital-to-analog (D/A) conversion, speech coding/decoding, encryption/decryption, error detection and correction, bit stream translation, filtering, etc. The network interface 706 may also include transceiver, generally coupled to an antenna 708 that transmits the outgoing radio signals 710 and receives the incoming radio signals 712 associated with the wireless device 700.

The mobile computing arrangement 700 may also include an alternate network/data interface 714 coupled to the processing/control unit 702. The alternate interface 714 may include the ability to communicate on proximity networks via wired and/or wireless data transmission mediums. The alternate interface 714 may include the ability to communicate using Bluetooth, 802.11 Wi-Fi, Ethernet, IRDA, USB, Firewire, RFID, and related networking and data transfer technologies.

The mobile computing arrangement 700 is designed for user interaction, and as such typically includes user-interface 716 elements coupled to the processing/control unit 702. The user-interface 716 may include, for example, a display such as a liquid crystal display, a keypad, speaker, microphone, etc. These and other user-interface components are coupled to the processor 702 as is known in the art. Other user-interface mechanisms may be employed, such as voice commands, switches, touch pad/screen, graphical user interface using a pointing device, trackball, joystick, or any other user interface mechanism.

The storage/memory 704 of the mobile computing arrangement 700 may include software modules for performing ASR on incoming or outgoing voice traffic communicated via any of the network interfaces (e.g., main and alternate interfaces 706, 714). In particular, the storage/memory 704 includes ASR specific processing modules 718. The processing modules handle 718 ASR specific task related to accessing and processing voice signals, converting speech to text, and processing the text. The storage/memory 704 may contain any combination or subcombination of the illustrated modules 718, as well as additional ASR-related modules known to one of skill in the art.

The ASR processing modules 718 include a feature extraction module 720 which extracts features from speech signals. The extracted features may include spectral and/or tonal features usable for various speech recognition frameworks. The feature extraction module 720 may be a DSR front-end client, or may be part of a self contained ASR program. A speech conversion module 722 takes features provided by the feature extraction module 720 (or other processing element) and converts the features to text. The speech conversion module 722 may be configured as a DSR back-end server, or may be part of a self contained ASR processor.

The text output of the speech conversion module 722 may be processed by a text processing/parsing module 724. The text processing module 724 may add formatting to text, perform spell and grammar checking, and parse informational text such as phone numbers and addresses. For example, the text processing/parsing module 724 may use regular expressions to find phone numbers within the text. In addition, the text processing/parsing parsing module 724 may be adapted to look for predetermined keywords, such as “record address” spoken by the user just before an address is recited.

The ASR processing modules 718 may also include a signaling module 728 that can be used with other software modules to control ASR functions. For example, the user interface 716 may be adapted to cause the processing modules 718 to begin speech recognition when a certain button is pressed. In addition, the signaling module 728 may communicate certain events to other software modules or network entities. For example, the signaling module 728 may signal to a contacts manager program that an address has been parsed and is ready for entry into the contacts list. The signaling module 728 may also communicate with other terminals and infrastructure servers to coordinate and synchronize DSR tasks, communicate compatible formats and protocols, etc.

Another functional module that may be included with the ASR processing modules 718 is a triggering module 729. The triggering module 729 controls the starting and stopping of voice recognition and/or text capture. The triggering module 729 will generally detect triggering events that are defined by the user. Such triggering events could be user initiated hardware events, such as the pressing of a button on the user interface 716. In other configurations, the triggering module 729 may use speech parameters or events detected by various parts of the ASR processing modules 718

For example, the triggering module 729 can detect certain triggering keywords or phrases that are processed by the speech conversion module 722 and/or text processing module 724. In such a configuration, the ASR processing modules 718 will continuously perform some level of speech conversion in order to detect the word patterns that serve as a triggering event. The triggering module 729 could also detect any other voice or sound characteristics processed by the feature extraction 720 and/or speech conversion module, such as intonation, timing of certain voice events, sounds uttered by the user, etc. In this configuration, the ASR processing modules 718 may not have to perform full speech recognition, although feature extraction may still be required.

The triggers detected by the triggering module 729 could be specified for both starting and stopping voice recognition and/or text capture. As well, certain triggers could give hints as to how the detected data should be classified. For example, if the phrase “what is the address?” is recognized as a trigger, any data captured with that trigger could be automatically converted to an address data object for addition to a contacts database. It will be appreciated that the triggering module 729 could trigger speech recognition events using any intelligence models known in the art. Of course, the user could also configure the triggering module 729 to simply record all text, such that the triggering events include the starting and stopping of a phone call.

The triggering module 729 (or other functional module) could also be arranged to interact with the user in order to deal with currently buffered conversation text. For example, if the ASR processing modules 718 have no predefined behavior in dealing with conversation text, the user may be prompted after completion of a call whether to save some or all of the text. The user may be able to choose among various options such as saving the entire conversation text, or saving various objects representing information portions of the text. For example, after the conversation, the user may be presented with icons representing a text file, an address object, a phone number object, and other informational objects. The user can then select objects for permanent storage. Even without the user saving the text immediately after the call, the modules 718 may be able to allocate a certain amount of memory storage for call text/objects, and automatically save the data. The modules 718 can overwrite older, unsaved data when the allocated memory storage begins to fill up.

The storage/memory 704 may also contain other programs and modules that interact with the ASR processing modules 718 but are not speech-recognition-specific. For example, a messaging module 730 may be used to send and receive text message containing converted text. Applications 732 may receive formatted or unformatted text that is produced the ASR processing modules 718. For example, applications 732 such as address books, contact managers, word processors, spreadsheets, databases, Web browsers, email, etc., may accept as input informational text that is recognized from speech.

The storage/memory 704 also typically includes one or more voice encoding and decoding module 734 to control the processing of speech sent and received over digital networks. The ASR processing modules 718 may access the digital or analog voice streams controlled by the voice encoding and decoding modules 734 for speech recognition. In addition, an analog processing module 736 may be included for accessing voice streams on analog networks.

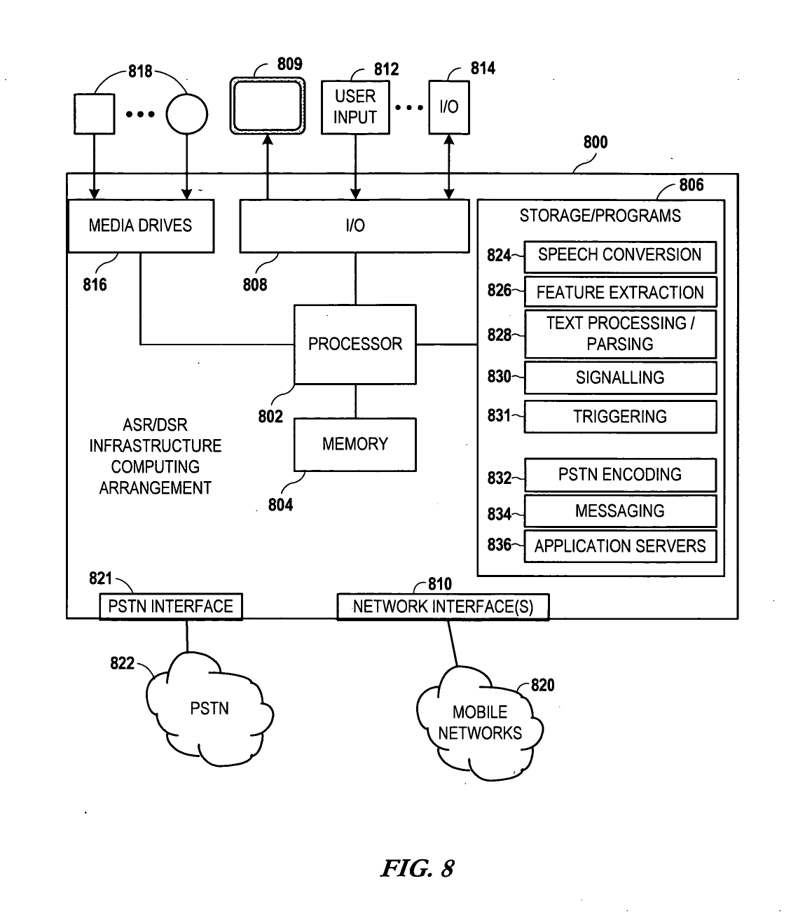

The mobile communication arrangement 700 may include entirely self-contained speech recognition, such that no modifications to the mobile communications infrastructure are required. However, as described in greater detail hereinabove, there may be some advantages to performing some portions of speech recognition in the infrastructure. In reference now to FIG. 8, a block diagram shows a representative computing arrangement 800 capable of carrying out ASR/DSR infrastructure operations in accordance with the invention.

The computing arrangement 800 is representative of functions and structures that may be incorporated in one or more machines distributed throughout a mobile communications infrastructure. The computing arrangement 800 includes a central processor 802, which may be coupled to memory 804 and data storage 806. The processor 802 carries out a variety of standard computing functions as is known in the art, as dictated by software and/or firmware instructions. The storage 806 may represent firmware, random access memory (RAM), hard-drive storage, etc. The storage 806 may also represent other types of storage media to store programs, such as programmable ROM (PROM), erasable PROM (EPROM), etc.

The processor 802 may communicate with other internal and external components through input/output (I/O) circuitry 808. The computing arrangement 800 may therefore be coupled to a display 809, which may be any type of display or presentation screen such as LCD displays, plasma display, cathode ray tubes (CRT), etc. A user input interface 812 is provided, including one or more user interface mechanisms such as a mouse, keyboard, microphone, touch pad, touch screen, voice-recognition system, etc. Any other I/O devices 814 may be coupled to the computing arrangement 800 as well.

The computing arrangement 800 may also include one or more media drive devices 816, including hard and floppy disk drives, CD-ROM drives, DVD drives, and other hardware capable of reading and/or storing information. In one embodiment, software for carrying out the data insertion operations in accordance with the present invention may be stored and distributed on CD-ROM, diskette or other form of media capable of portably storing information, as represented by media devices 818. These storage media may be inserted into, and read by, the media drive devices 816. Such software may also be transmitted to the computing arrangement 800 via data signals, such as being downloaded electronically via one or more network interfaces 810.

The computing arrangement 800 may be coupled one or more mobile networks 820 via the network interface 810. The network 820 generally represents any portion of the mobile services infrastructure where voice and signaling can be communicated between mobile devices. The computing arrangement 800 may also contain a PSTN interface 821 for communicating with elements of a PSTN 822.

Generally, the data storage 806 of the computing arrangement 800 contains computer instructions for carrying out various ASR/DSR tasks of the mobile infrastructure. A speech conversion module 824 may be capable of acting as a DSR back-end server for performing speech recognition on behalf of mobile terminals having a feature extraction front end (e.g., module 720 in FIG. 7). In addition, the arrangement 800 may include a feature extraction module 826 in order to provide speech recognition for elements that do not have a DSR front-end client. For example, the feature extraction module 826 may be used to perform speech recognition on calls placed over the PSTN 822 before the calls are encoded for transmission over digital networks, such as by a PSTN encoding module 832.

A text processing and parsing module 828 may receive text from the speech conversion module 824 and provide formatting and error correction. A signaling module 830 can synchronize events between DSR server and client elements, and provide a mechanism for communicating other ASR related data between network elements. A triggering module 831 could, based on configuration settings, detect triggering events that signal the start and stop of recognition and/or capture, as well as controlling the disposition of recorded text and data objects once recognition is complete. The triggering module 831 may be configured to operate similarly to the triggering module 729 in FIG. 7. The triggering module 831 may detect events contained in any combination of analog voice signals and digitally-encoded voice signals. The triggering module 831 may also detect events occurring at a conversation endpoint, such as a start/stop signal sent from a mobile device.

Various other functional modules of the computing arrangement 800 may also interact with the ASR specific modules described above. The PSTN encoding module 832 may provide access to unencoded PSTN voice traffic in order to more effectively perform speech recognition. A messaging module 834 may be used to receive triggering events sent from remote devices and pass those events to the triggering module 831. The messaging module/interface 834 may also be used to communicate ASR-derived text to users using legacy messaging protocols such as SMS and MMS. Similarly, the ASR-derived text may be made available by other means via application servers 836. The application servers 836 may enable text storage and access via Web browsers or customized mobile applications. The application servers 836 may also be used to manage user preferences related to infrastructure ASR processing.

The computing arrangement 800 of FIG. 8 is provided as a representative example of computing environments in which the principles of the present invention may be applied. From the description provided herein, those skilled in the art will appreciate that the present invention is equally applicable in a variety of other currently known and future mobile and landline computing environments. Thus, the present invention is applicable in any known computing structure where data may be communicated via a network.

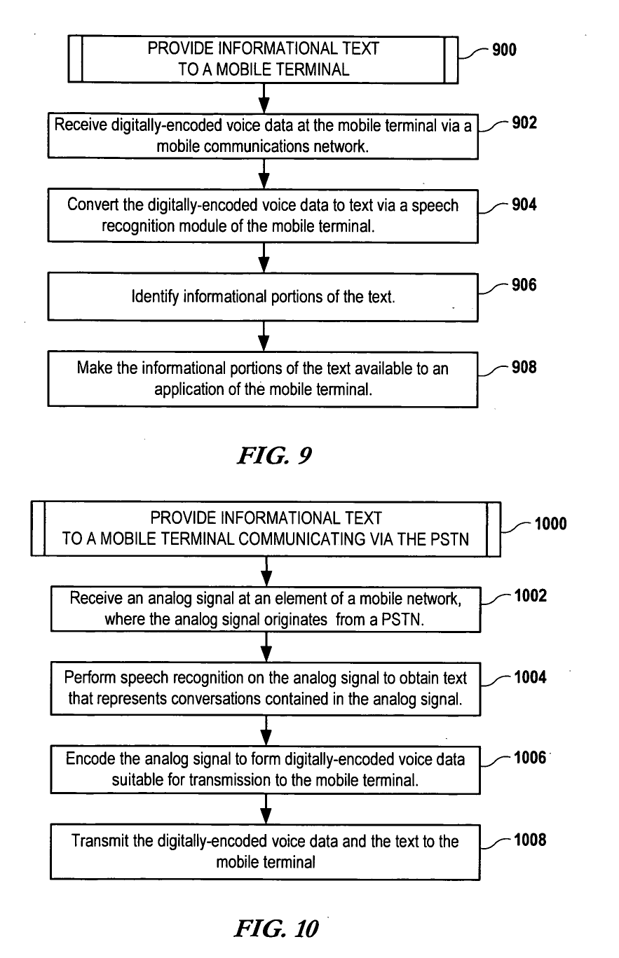

In reference now to FIG. 9, a flowchart illustrates a procedure 900 for providing informational text to a mobile terminal capable of being coupled to a mobile communications network. The procedure involves receiving (902) digitally-encoded voice data at the mobile terminal via the network. The digitally-encoded voice data is converted (904) to text via a speech recognition module of the mobile terminal, and informational portions of the text are identified (906). The informational portions of the text are made available (908) to an application of the mobile terminal.

In reference now to FIG. 10, a flowchart illustrates a procedure 1000 for providing informational text to a mobile terminal that is communicating via the PSTN. The procedure involves receiving (1002) an analog signal at an element of a mobile network. The analog signal originates from a public switched telephone network. Speech recognition is performed (1004) on the analog signal to obtain text that represents conversations contained in the analog signal. The analog signal is encoded (1006) to form digitally-encoded voice data suitable for transmission to the mobile terminal. The digitally-encoded voice data and the text are transmitted (1008) to the mobile terminal.

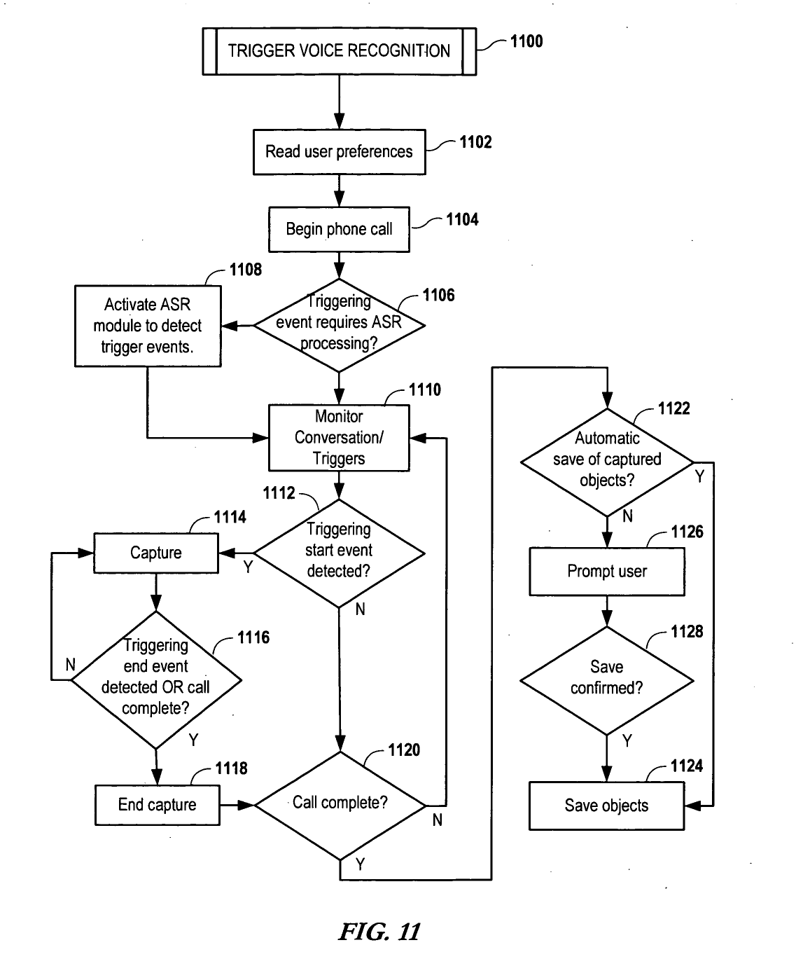

In reference now to FIG. 11, a flowchart illustrates a procedure 1100 for triggering voice recognition and text capture according to an embodiment of the invention. The procedure 110 may be performed, in whole or in part, on a mobile terminal, infrastructure processing apparatus, and any other centralized or distributed computing elements. The procedure 1100 involves reading (1102) user preferences in order to determine the parameters and logic used to capture and store information extracted from voice conversations. The triggering logic for information capture is typically activated when a call begins (1104). If the triggering event requires (1106) some sort of ASR processing (e.g., feature detection, word pattern detection) then an ASR module may be activated (1108) in order to detect trigger events. Otherwise, the trigger events may be detected by some other software elements, such as a user interface program or call handling routine.

As the conversation proceeds, either the conversation or other trigger event (e.g., hardware interrupt) is monitored (1110) for triggering events. If an event is detected (1112), information is captured (1114) by an ASR module. During the capture (1114), monitoring for trigger events continued. The events could be additional start event triggers within the original event detection (1112). For example, the user could want the entire conversation captured (the first start triggering event) plus have any addresses spoken in the conversation (the secondary start triggering event) be specially processed for form address objects for placement into a contact list. If the phone call ends and/or end triggering event is detected (1116), capture ends (1118).

When the phone call is completed (1120), additional logic may be used in order to properly store captured information. If the user preference indicates (1122) an automatic save, then the text/objects can immediately be saved (1124). Otherwise the user may be prompted (1126) and the object saved (1124) based on user confirmation (1128).

Hardware, firmware, software or a combination thereof may be used to perform the various functions and operations described herein. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a system, apparatus, and method in accordance with the present invention.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather defined by the claims appended hereto.

What is claimed is:

1. A processor-implemented method of providing informational text to a mobile terminal capable of being coupled to a mobile communications network, comprising:
receiving digitally-encoded voice data at the mobile terminal via the network;
converting the digitally-encoded voice data to text via a speech recognition module of the mobile terminal;
identifying informational portions of the text; and
making the informational portions of the text available to an application of the mobile terminal.

2. The method of claim 1, wherein identifying the informational portions of the text comprises identifying contact information in the text.

3. The method of claim 2, making the informational portions of the text as available to an application program of the mobile terminal comprises adding the contact information of the text to a contacts database of the mobile terminal.

4. The method of claim 1, wherein identifying the informational portions of the text comprises identifying at least one of a telephone number and an address in the text.

5. The method of claim 1, wherein converting the digitally-encoded voice data to text via the speech recognition module of the mobile terminal comprises:
extracting speech recognition features from the digitally-encoded voice data;
sending the speech recognition features to a server of a mobile communications network;
converting the features to the text at the server; and
sending the text from the server to the mobile terminal.

6. The method of claim 1, further comprising:
performing speech recognition on a portion of speech recited by a user of the mobile terminal to obtain verification text, wherein the portion of speech is the result of the user repeating an original portion of speech received via the network; and
verifying the accuracy of the informational portions of the text based on the verification text.

7. The method of claim 1, further comprising:
receiving analog voice at the mobile terminal via the network; and
converting the analog voice to text via the speech recognition module of the mobile terminal.

8. The method of claim 1, wherein converting the digitally-encoded voice data to text via the speech recognition module of the mobile terminal comprises:
performing at least a portion of the conversion the digitally-encoded voice data to text via a server of a mobile communications network; and
sending the text from the server to the mobile terminal using a mobile messaging infrastructure.

9. The method of claim 8, wherein sending the text from the server to the mobile terminal using the mobile messaging infrastructure comprises sending the text using at least one of Short Message Service and Multimedia Message Service.

10. The method of claim 1, wherein converting the digitally-encoded voice data to text via the speech recognition module of the mobile terminal comprises converting the digitally-encoded voice data to text in response to detecting a triggering event.

11. The method of claim 10, wherein detecting the triggering event comprises detecting the triggering event from the digitally-encoded voice data.

12. The method of claim 11, wherein detecting the triggering event from the digitally-encoded voice data comprises detecting the triggering event based on a voice intonation derived from the digitally-encoded voice data.

13. The method of claim 11, wherein detecting the triggering event from the digitally-encoded voice data comprises detecting the triggering event based on a word pattern derived from the digitally-encoded voice data.

14. A processor-implemented method of providing informational text to a mobile terminal, comprising:
receiving an analog signal at an element of a mobile network, the analog signal originating from a public switched telephone network;
performing speech recognition on the analog signal to obtain text that represents conversations contained in the analog signal;
encoding the analog signal to form digitally-encoded voice data suitable for transmission to the mobile terminal; and
transmitting the digitally-encoded voice data and the text to the mobile terminal.

15. The method of claim 14, further comprising:
identifying informational portions of the text; and
making the informational portions available to an application of the mobile terminal.

16. The method of claim 15, wherein identifying the informational portions of the text comprises identifying contact information in the text, and wherein making the informational portions of the text as available to an application program of the mobile terminal comprises adding contact information of the text to a contacts database of the mobile terminal.

17. The method of claim 14, further comprising:
performing speech recognition on a portion of speech recited by a user of the mobile terminal to obtain verification text, wherein the portion of speech is formed by the user repeating an original portion of speech received at the mobile terminal via the network; and
verifying the accuracy of the informational portions of the text based on the verification text.

18. The method of claim 14, wherein performing speech recognition on the analog signal comprises performing speech recognition on the analog signal in response to detecting a triggering event.

19. The method of claim 18, wherein detecting the triggering event comprises detecting the triggering event from the analog signal.

20. The method of claim 19, wherein detecting the triggering event from the analog signal comprises detecting the triggering event derived from a voice intonation detected in the analog signal.

21. The method of claim 19, wherein detecting the triggering event from the analog signal comprises detecting the triggering event derived from a word pattern detected in the analog signal.

22. A mobile terminal, comprising:
a network interface capable of communicating via a mobile communications network;
a processor coupled to the network interface; and
a memory coupled to the processor, the memory having at least one user application and a speech recognition module that causes the processor to,
receive digitally-encoded voice data via the network interface;
perform speech recognition on the digitally-encoded voice data to obtain text that represents speech contained in the encoded voice data;
identify informational portions of the text; and
make the informational portions of the text available to the user application.

23. The mobile terminal of claim 22, wherein the informational portions of the text comprises contact information.

24. The mobile terminal of claim 23, wherein the user application comprises a contacts database, and wherein the speech recognition module causes the processor to make the contact information available to the contacts database.

25. The mobile terminal of claim 22, wherein informational portions of the text comprises at least one of a telephone number and an address.

26. The mobile terminal of claim 22, wherein the speech recognition module causes the processor to,
extract speech recognition features from the digitally-encoded voice data received at the mobile terminal;
send the speech recognition features to a server of the mobile communications network to convert the features to the text at the server; and
receive the text from the server.

27. The mobile terminal of claim 22, wherein the speech recognition module causes the processor to,
perform at least a portion of the conversion of the digitally-encoded voice data received at the mobile terminal to text via a server of the mobile communications network; and
receive at least a portion of the text from the server.

28. The mobile terminal of claim 27, further comprising a mobile messaging module having instructions that cause the processor to receive at least the portion of the text from the service using a mobile messaging infrastructure.

29. The mobile terminal of claim 28, wherein the mobile messaging module uses at least one of Short Message Service and Multimedia Message Service.

30. The mobile terminal of claim 22, further comprising a microphone; and
wherein the speech recognition module further causes the processor to,
perform speech recognition on a portion of speech recited by a user of the mobile terminal into the microphone to obtain verification text, wherein the portion of speech is formed by the user repeating an original portion of speech received at the mobile terminal via the network interface; and
verify the accuracy of the informational portions of the text based on the verification text.

31. The mobile terminal of claim 22, wherein the speech recognition module further causes the processor to,
receive analog voice via the network interface; and
convert the analog voice to text.

32. The mobile terminal of claim 22, further comprising a triggering module that causes the processor to,
detecting triggering events; and
control activation of the speech recognition module in response to the triggering events.

33. The mobile terminal of claim 32, wherein the triggering module detects the triggering event from the digitally-encoded voice data.

34. The mobile terminal of claim 33, wherein the triggering module detects the triggering event derived from a voice intonation detected in the digitally-encoded voice data.

35. The mobile terminal of claim 33, wherein the triggering module detects the triggering event derived from a word pattern detected in the digitally-encoded voice data.

36. A processor-readable medium having instructions stored thereon which are executable by a data processing arrangement capable of being coupled to a network to perform steps comprising:
receiving encoded voice data at the mobile terminal via the network;
converting the encoded voice data to text via an advanced speech recognition module of the mobile terminal;
identifying informational portions of the text; and
making the informational portions available to an application of the mobile terminal.

37. A mobile terminal comprising:
means for receiving encoded voice data at the mobile terminal;
means for converting the encoded voice data to text;
means for identifying informational portions of the text; and
means for making the informational portions available to an application of the mobile terminal.

38. The mobile terminal of claim 37, further comprising:
means for performing speech recognition on a portion of speech repeated by a user of the mobile terminal to obtain verification text; and
means for verifying the accuracy to the informational portions of the text based on the verification text.

39. The mobile terminal of claim 37, further comprising:
means for receiving analog voice via the network interface; and
means for converting the analog voice to text.

40. The mobile terminal of claim 37, further comprising:
means for detecting a triggering event from the encoded voice data; and
means for controlling the activation of converting encoded voice data to text based on the triggering event.

41. A system comprising:
means for receiving analog voice originating from a public switched telephone network;
means for performing speech recognition on the analog voice to obtain text that represents conversations contained in the analog voice;
means for encoding the analog voice to form encoded voice data suitable for transmission to the mobile terminal; and
means for transmitting the encoded voice data and the text to the mobile terminal.

42. The system of claim 41, further comprising:
means for detecting a triggering event from the analog voice; and
means for controlling the activation of speech recognition based on the triggering event.

43. A data-processing arrangement, comprising:
a network interface capable of communicating with a mobile terminal via a mobile network;
a public switched telephone network (PSTN) interface capable of communicating via a PSTN;
a processor coupled to the network interface and the PSTN interface; and
a memory coupled to the processor, the memory having instructions that cause the processor to,
receive analog voice originating from the PSTN and targeted for the mobile terminal;
perform speech recognition on the analog voice to obtain text that represents conversations contained in the analog voice;
encode the analog voice to form encoded voice data suitable for transmission to the mobile terminal; and
transmit the encoded voice data and the text to the mobile terminal.
